(19) United States
(12) Patent Application Publication
(10) Pub. No.: US 2014/0002106 A1
(43) Pub. Date: Jan. 2, 2014

(54) MICROWAVE IMAGING BREAST PHANTOM, METHOD FOR TESTING RELIABILITY OF BREAST CANCER DIAGNOSTIC APPARATUS USING THE PHANTOM, AND BREAST CANCER DIAGNOSTIC APPARATUS INCLUDING THE PHANTOM

(71) Applicant: ELECTRONICS AND TELECOMMUNICATIONS RESEARCH INSTITUTE, Daejeon (KR)

(72) Inventors: Jong Moon LEE, Chungcheongbuk-do (KR); Hyuk Je KIM, Daejeon (KR); Seong-Ho SON, Daejeon (KR); Soon Ik JEON, Daejeon (KR); Hyung Do CHOI, Seoul (KR)

(21) Appl. No.: 13/928,041

(22) Filed: Jun. 26, 2013

(30) Foreign Application Priority Data
Jul. 2, 2012 (KR) 10-2012-0071994

(51) Int. Cl. G01N 22/00

(52) U.S. Cl. CPC G01N 22/00
USPC 324/601; 324/637

(57) ABSTRACT

The present invention relates to a microwave imaging breast phantom including a simulated breast tissue phantom and a simulated cancer tissue phantom, wherein the simulated cancer tissue phantom is included in the simulated breast tissue phantom, the simulated breast tissue and the simulated cancer tissue are separated from each other, the simulated breast tissue and the simulated cancer tissue are formed by using a solvent solely or mixing water and a solvent, and the solvent having a range in which assuming that specific gravity of the water is a and specific gravity of the solvent is b, ‘(b−a)/a×100’ is about −10 to about +10 (wherein 0 is excluded) is mixed with the water, a method of testing reliability of a breast cancer diagnostic apparatus using the microwave imaging breast phantom, and a breast cancer diagnostic apparatus including the microwave imaging breast phantom.

### CROSS-REFERENCES TO RELATED APPLICATIONS

The present application claims priority under 35 U.S.C 119(a) to Korean Application No. 10-2012-0071994, filed on Jul. 2, 2012, in the Korean Intellectual Property Office, which is incorporated herein by reference in its entirety set forth in full.

### BACKGROUND

Exemplary embodiments of the present invention relate to a microwave imaging breast phantom, a method of testing reliability of a breast cancer diagnostic apparatus using the phantom, and a breast cancer diagnostic apparatus including the phantom. More particularly, exemplary embodiments of the present invention relate to a microwave imaging breast phantom which can be used to diagnose breast cancer more precisely than other substances owing to stable electrical characteristics because the phantom is not separated over time, which can diagnose breast cancer easily because the phantom has similar electrical characteristics to the breast tissue and the cancer tissue of a real human body, and which can be fabricated using a simple method, a method of testing reliability of a breast cancer diagnostic apparatus using the phantom, and a breast cancer diagnostic apparatus including the phantom.

The present invention has been derived from researches carried out as part of Electric Wave Broadcasting Satellite Source Technology Development Project supported by Korea Communications Commission (KCA-2012-11911-01-108).

Recently, breast cancer stands first in the cancer of Korean women. Lots of researches are being carried out on diagnoses and treatment for breast cancer. There have been lots of researches into prevention, medical examination, and a method of medical treatment because there is a good possibility that breast cancer can be cured completely if it is early diagnosed and properly treated.

Today a variety of diagnostic apparatuses, such as an ultrasonic diagnostic apparatus, X-ray, or MRI, are used as methods of diagnosing breast cancer.

The ultrasonic diagnostic apparatus, however, is problematic in that the accuracy of breast cancer diagnosis is low because resolution is low in determining a cancer tissue. X-ray is used to diagnose a cancer tissue by penetrating radioactive rays through the human body, and the radioactive rays are very harmful to the human body. Furthermore, if radioactive rays are penetrated through the human body, there is a problem in that the radioactive rays remain in the human body. MRI has high contrast between a cancer tissue and breast tissue, but is disadvantageous in that it requires lots of costs and a long test time.

As methods of solving the problems of the methods of diagnosing breast cancer, diagnostic equipment using microwaves is being developed. However, there is a problem in that valid data capable of checking the accuracy or performance of breast cancer diagnostic equipment using microwaves is insufficient in a process of developing and fabricating the diagnostic equipment.

It is thus necessary to check the performance of diagnostic equipment and perform clinical experiments using a breast phantom having similar electrical characteristics to the breast in a process of fabricating breast cancer diagnostic equipment using microwaves. However, a breast phantom for evaluating the performance of breast cancer diagnostic equipment using microwaves has not been sufficiently developed worldwide.

As a related art, Korean Patent Registration No. 10-1026833 (Mar. 28, 2011), entitled ‘Manufacturing Method of Mammary Phantom for The Diagnosis Equipment of Breast Tumor Using Electromagnetic Wave’, discloses a technique for fabricating a liquid type fat tissue phantom using triton-X 100 of 75-85 wt %, diethyleneglycolbutylether of 15-25 wt %, and salt water of 0.1-5 wt % in a saturated state, fabricating a gel type streamline tissue phantom by mixing glycerol of 30-40 wt %, ultra pure water of 50 to 60 wt %, sodium chloride of 1-5 wt %, agar of 2-6 wt %, and polyethylene power of 1-5 wt %, and fabricating a gel type cancer tissue phantom by mixing glycerol of 30-40 wt %, ultra pure water of 50 to 60 wt %, sodium chloride of 1-5 wt %, agar of 2-6 wt %, and polyethylene power of 1-5 wt %.

### SUMMARY

An embodiment of the present invention relates to a microwave imaging breast phantom which can diagnose breast cancer easily owing to similar electrical characteristics (e.g., relative permittivity and/or conductivity) to the breast tissue and/or the cancer tissue of the human body.

Another embodiment of the present invention relates to a microwave imaging breast phantom which can diagnose breast cancer more accurately than other substances owing to stable electrical characteristics because the phantom is not separated over time.

Another embodiment of the present invention relates to a microwave imaging breast phantom which can be simply fabricated using only two types of materials without using a complicated manufacture method.

Another embodiment of the present invention relates to a method of testing reliability of a breast cancer diagnostic apparatus using the microwave imaging breast phantom.

Another embodiment of the present invention relates to a breast cancer diagnostic apparatus including the microwave imaging breast phantom.

In one embodiment, a microwave imaging breast phantom includes a simulated breast tissue phantom and a simulated cancer tissue phantom, wherein the simulated cancer tissue phantom is included in the simulated breast tissue phantom, the simulated breast tissue and the simulated cancer tissue are separated from each other, the simulated breast tissue and the simulated cancer tissue are respectively formed by using a solvent solely or mixing water and a solvent, and the solvent having a range in which assuming that specific gravity of the water is a and specific gravity of the solvent is b, ‘(b−a)/a×100’ is about −10 to about +10 (wherein 0 is excluded) is mixed with the water.

In a detailed example, the simulated breast tissue phantom can have relative permittivity of about 6 to 14 and conductivity of about 0.8 to 1.8 S/m in a frequency of 3 GHz.

In a detailed example, the simulated cancer tissue phantom can have relative permittivity of about 50 to 60 and conductivity of about 1 to 4 S/m in a frequency of 3 GHz to 1.3 GHz.

In a detailed example, the simulated breast tissue can include one or more of a tissue formed of the solvent 100% based on content, a tissue formed by mixing the solvent of about 95% and water of about 5% based on content, a tissue formed by mixing the solvent of about 90% and water of about 10% based on content, and a tissue formed by mixing the solvent of about 85% and water of about 15% based on content.

In a detailed example, the simulated cancer tissue can include one or more of a tissue formed by mixing the solvent of about 40% and water of about 60% based on content and a tissue formed by mixing the solvent of about 50% and water of about 50% based on content.

In a detailed example, the solvent can include propyleneglycol.

In another embodiment, a method of testing reliability of a breast cancer diagnostic apparatus can include using the microwave imaging breast phantom.

In another embodiment, a breast cancer diagnostic apparatus can include a microwave imaging breast phantom.

### BRIEF DESCRIPTION OF THE DRAWINGS

The above and other aspects, features and other advantages will be more clearly understood from the following detailed description taken in conjunction with the accompanying drawings, in which:

FIG. 1 is a cross-sectional view of a phantom in accordance with one embodiment of the present invention;

FIG. 2 a cross-sectional view of a phantom in accordance with another embodiment of the present invention;

FIGS. 3 to 6 are photographs of four types of typical breasts models, wherein FIG. 3 is an FT breast tissue, FIG. 4 is an SC breast tissue, FIG. 5 is an HD breast tissue, and FIG. 6 is an ED breast tissue;

FIG. 7 shows relative permittivity of four types of simulated breast tissue phantoms and simulated cancer tissue phantom measured in a frequency of 300 MHz to 6 GHz;

FIG. 8 shows conductivity of four types of simulated breast tissue phantoms and simulated cancer tissue phantom measured in a frequency of 300 MHz to 6 GHz; and

FIG. 9 is a side view of a breast cancer diagnostic apparatus in accordance with one embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

A microwave imaging breast phantom in accordance with one aspect of the present invention includes a simulated breast tissue phantom and a simulated cancer tissue phantom.

The simulated breast tissue phantom has relative permittivity of about 6 to 14 and conductivity of about 0.8 to 1.8 S/m in a frequency 3 GHz, and the simulated cancer tissue phantom has relative permittivity of about 50 to 60 and conductivity of about 1 to 4 S/m in a frequency 3 GHz to 1.3 GHz.

The relative permittivity and conductivity values of breast tissue of a human being are obtained by combining the electrical characteristics of fat tissue and streamline tissue that form the breast. Furthermore, the relative permittivity and conductivity values of a real cancer tissue result from the electrical characteristics of an abnormal tissue that forms a cancer tissue.

The simulated breast tissue phantom and the simulated cancer tissue phantom that form the microwave imaging breast phantom of the present invention have very similar relative permittivity and conductivity to the breast tissue and the cancer tissue of a human being.

The microwave imaging breast phantom of the present invention is fabricated in such a manner that a simulated breast tissue and a simulated cancer tissue are respectively formed by a solvent solely or mixing water and a solvent, wherein assuming that specific gravity of water is a and specific gravity of the solvent is b, the solvent having a range in which ‘(b−a)/a×100’ is about −10 to about +10 (wherein 0 is excluded) is mixed with water, a simulated breast tissue phantom and a simulated cancer tissue phantom are formed by injecting the simulated breast tissue and the simulated cancer tissue into respective supports.

In general, in the diagnosis of breast cancer using microwave imaging, breast tissue, although not limited, is classified into four types of tissues. More particularly, breast tissue can be classified into four typical types: a breast tissue (Fatty, FT) chiefly composed of fat, a breast tissue (SCattered, SC) in which streamline tissues are scattered, a breast tissue (Heterogeneously Dense, HD) in which streamline tissues are irregularly crowded, and a breast tissue (Extremely Dense, ED) in which streamline tissues are extremely crowded.

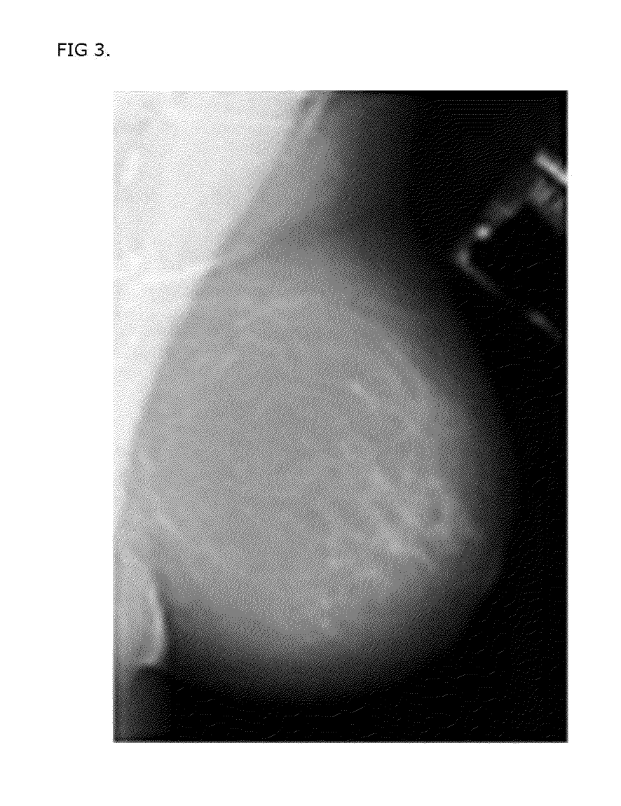

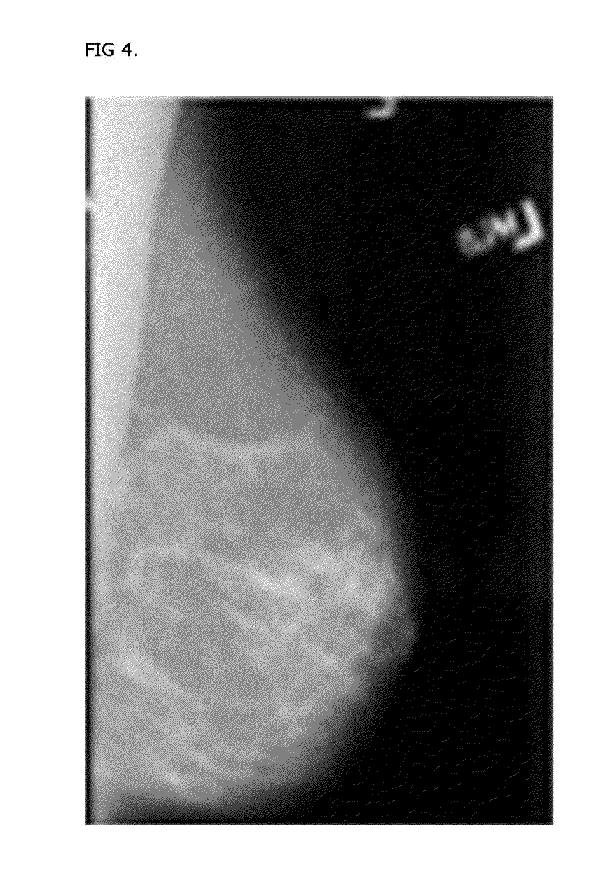

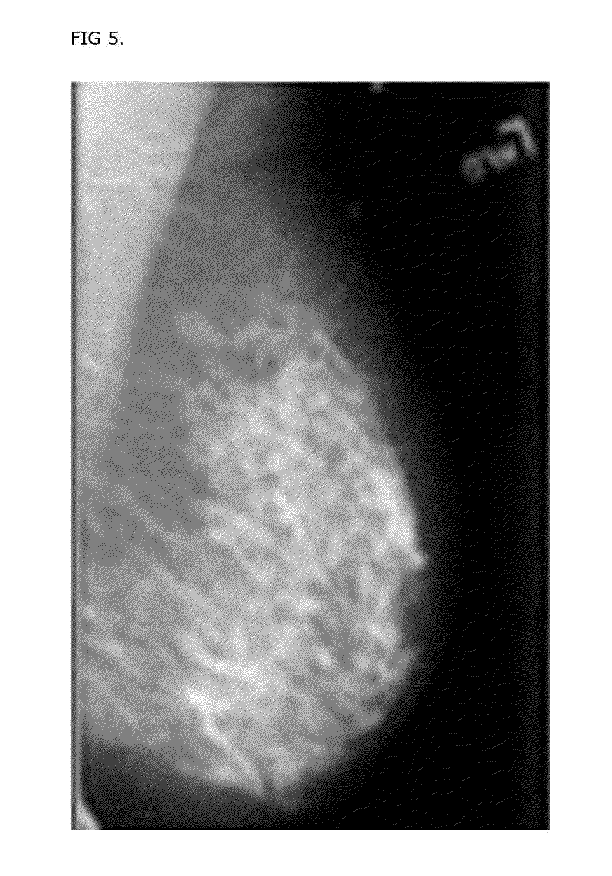

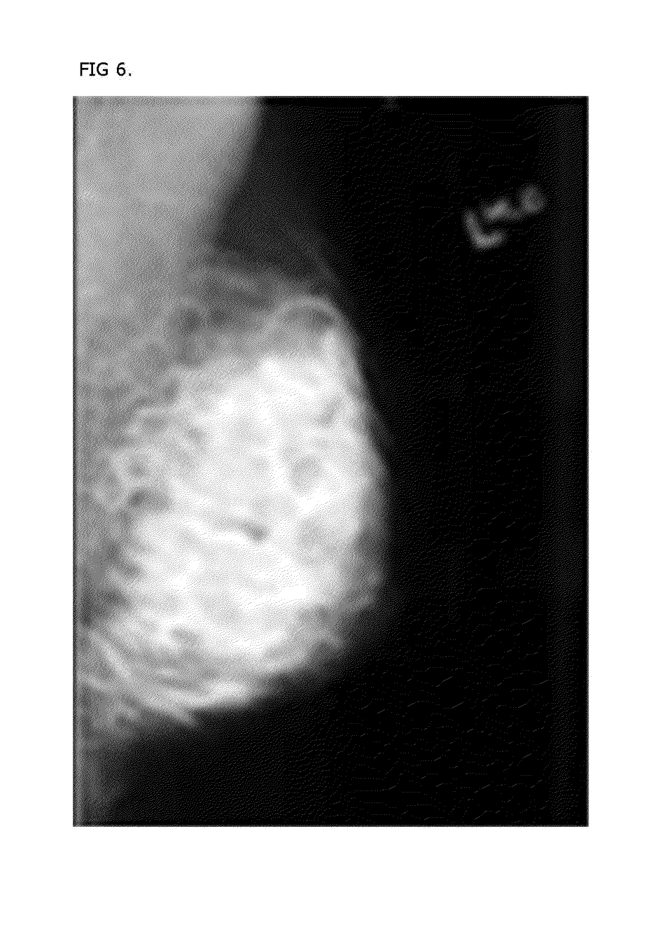

FIGS. 3 to 6 show the four types of typical breast tissues.

The above-described breast tissues typically have relative permittivity of about 6 to 14 and conductivity of about 0.8 to 1.8 S/m in a frequency 3 GHz.

The simulated breast tissue phantom of the present invention includes a simulated breast tissue formed by using a solvent solely or mixing water and a solvent. Here, assuming that specific gravity of water is a and specific gravity of the solvent is b, the solvent having a range in which ‘(b−a)/a×100’ is about −10 to about +10 (wherein 0 is excluded) is mixed with water.

The simulated breast tissue phantom of the present invention also has similar relative permittivity and conductivity in the frequency range to the four types of breast tissues.

Furthermore, real cancer tissue typically has relative permittivity of about 50 to 60 and conductivity of about 1 to 4 S/m in a frequency 3 GHz to 1.3 GHz.

In the imaging phantom of the present invention, the simulated cancer tissue phantom includes a simulated cancer tissue formed by using a solvent solely or mixing water and a solvent. Here, the solvent having a range in which assuming that specific gravity of water is a and specific gravity of the solvent is b, ‘(b−a)/a×100’ is about −10 to about +10 (wherein 0 is excluded) is mixed with water.

The simulated cancer tissue phantom of the present invention also has similar relative permittivity and conductivity in the frequency range to the real cancer tissue.

In the microwave imaging breast phantom, if a solvent having the range in which ‘(b−a)/a×100’ is less than about −10 or more than about +10 (wherein 0 is excluded) is used, a phantom cannot be formed because the solvent is not well mixed with water. Furthermore, although the solvent is mixed with water, the solvent is separated from water over time and stable electrical characteristics cannot be obtained, with the result that efficiency of microwave imaging diagnostic test equipment cannot be measured.

‘(b−a)/a×100’ preferably can be about −5 to about +5 (wherein 0 is excluded), more preferably, about 0.001 to about 5.

A solvent is not specially limited if it has the above-described physical properties for example organic or aqueous solvent. More particularly, propyleneglycol (C₃H₈O₂, PG, specific gravity: 1.0381 g/cm³) may be used as the solvent.

In a detailed example, a simulated breast tissue can be formed by controlling a mixture ratio of water and a solvent. The four types of typical breast tissues can be formed by controlling a ratio of water and a solvent within water of about 0 to 15% and the solvent of about 85 to 100% based on content (volume). Preferably, the simulated breast tissue can be formed of a solvent of about 100%. For example, the simulated breast tissue can be formed of water of more than about 0% to about 15% and a solvent of about 85% to less than about 100%. For example, the simulated breast tissue can be formed of water of about 5 to 15% and a solvent of about 85 to 95%.

In this specification, ‘content’ means volume.

In an embodiment, a simulated FT breast tissue can be formed of a solvent of about 100% based on content (FT(PG100)). A simulated SC breast tissue can be formed by mixing a solvent of about 95% and water of about 5% based on content (SC(PG95)). A simulated HD breast tissue can be formed by mixing a solvent of about 90% and water of about 10% based on content (HD(PG90)). A simulated ED breast tissue can be formed by mixing a solvent of about 85% and water of about 15% based on content (ED(PG85)).

In the imaging phantom of the present invention, the simulated breast tissue can include one or more of the simulated FT breast tissue, the simulated SC breast tissue, the simulated HD breast tissue, and the simulated ED breast tissue.

As a result, the simulated breast tissue of the present invention has relative permittivity of about 6 to 14 and conductivity of about 0.8 to 1.8S/m in the above frequency of 3 GHz, and it can be used to test the reliability and performance of breast cancer diagnostic equipment as a common microwave imaging breast phantom.

In another detailed example, the simulated cancer tissue can be formed by controlling a mixture ratio of water and a solvent. Two types of typical cancer tissues can be formed by controlling a ratio of water and a solvent within water of about 50 to 60% and the solvent of about 40 to 50% based on content.

In an embodiment, a simulated cancer tissue can be formed by mixing a solvent of about 40% and water of about 60% based on content (a first cancer tissue, cancer(PG40)).

In another embodiment, a simulated cancer tissue can be formed by mixing a solvent of about 50% and water of about 50% based on content (a second cancer tissue).

In the microwave imaging breast phantom of the present invention, the simulated cancer tissue can include one or more of the first cancer tissue and the second cancer tissue.

As a result, the simulated cancer tissue of the present invention has relative permittivity of about 50 to 60 and conductivity of about 1 to 4 S/m in the above frequency of 3 GHz to 1.3 GHz.

The microwave imaging breast phantom of the present invention can include the simulated breast tissue phantom and the simulated cancer tissue phantom.

In a phantom, a simulated cancer tissue phantom is included in a simulated breast tissue phantom, but the simulated cancer tissue phantom and the simulated breast tissue phantom are separated from each other.

The simulated breast tissue and the simulated cancer tissue of the present invention have a liquid form, respectively. As a result, in order to shape the simulated breast tissue and the simulated cancer tissue into phantoms, the simulated breast tissue and the simulated cancer tissue are injected into the respective supports.

The support can be made of silicon, but not limited thereto.

The support can be fabricated in a membrane form by taking permeability of a microwave into consideration, but not limited thereto.

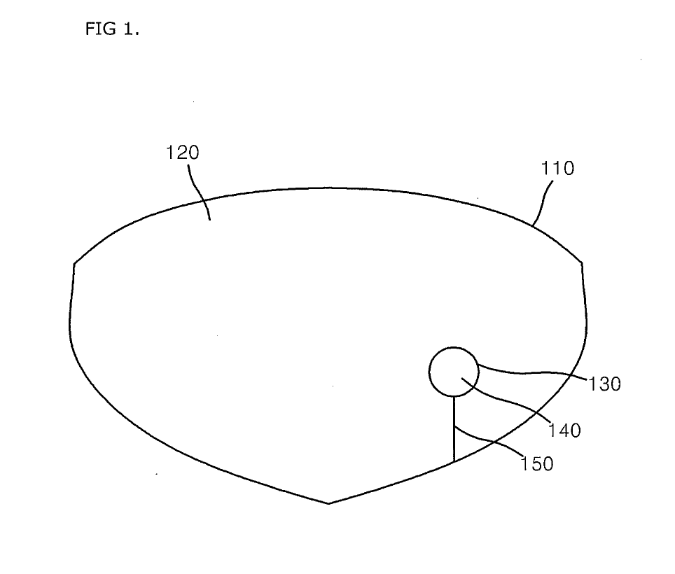

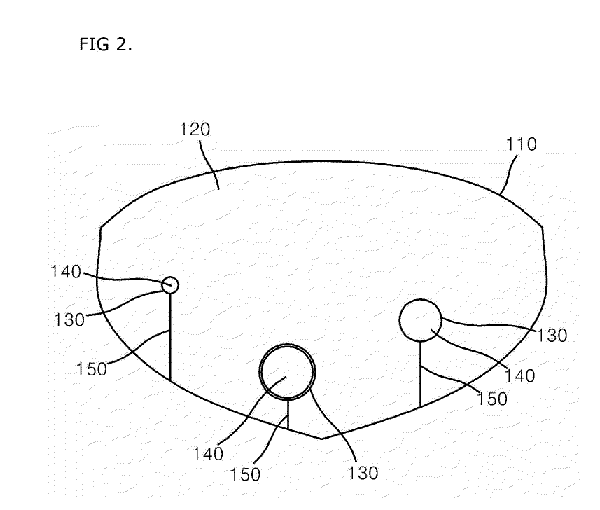

FIGS. 1 and 2 are cross-sectional views showing detailed examples of the microwave imaging breast phantom in accordance with the present invention.

As shown in FIG. 1, a phantom can include a simulated breast tissue phantom 120 into which a simulated breast tissue has been injected within a support 110 for supporting the simulated breast tissue and a simulated cancer tissue phantom 140 into which a simulated cancer tissue has been injected within a support 130 for supporting the simulated cancer tissue. The simulated cancer tissue phantom 140 can be fixed to a specific position in the simulated breast tissue through a support pole 150 or can be placed at a specific position within the simulated breast tissue without a support pole.

The support pole can be made of silicon, but not limited thereto.

FIG. 1 shows a phantom in which one cancer tissue phantom is included in a simulated breast tissue phantom.

However, a plurality of cancer tissues can exist within a breast tissue.

As shown in FIG. 2, a phantom can include a plurality of simulated cancer tissue phantoms 140 into which a simulated cancer tissue has been injected within a support 130 for supporting the simulated cancer tissue. The simulated cancer tissue phantom 140 can be fixed to specific positions in the simulated breast tissue by respective support pole 150 or can be scattered at specific positions within the simulated breast tissue without a support pole.

If a plurality of the simulated cancer tissue phantoms is used, a mixture ratio of a solvent and water, a form, and a size in simulated cancer tissues can be the same or different.

The imaging phantom of the present invention can be formed by combining one of the four types of breast tissues and one of the above-described cancer tissues. Furthermore, the imaging phantom of the present invention can be fabricated and used in various forms depending on the shape and size of the breast.

When fabricating the imaging phantom of the present invention, a simulated cancer tissue is fabricated and a simulated cancer tissue phantom is fabricated by injecting the fabricated simulated cancer tissue into a support. The microwave imaging breast phantom is fabricated by injecting the simulated cancer tissue phantom into a support for supporting a simulated breast tissue phantom and injecting the simulated breast tissue. The simulated cancer tissue phantom can be fixed by forming a support pole.

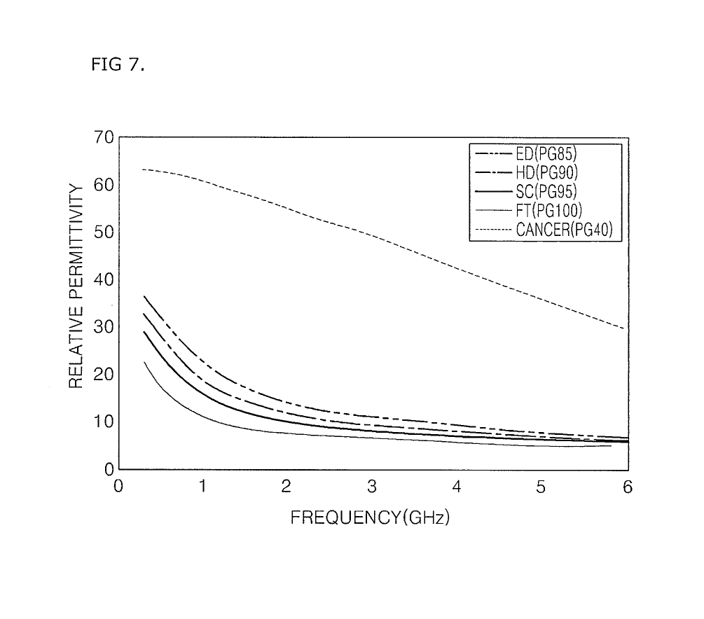

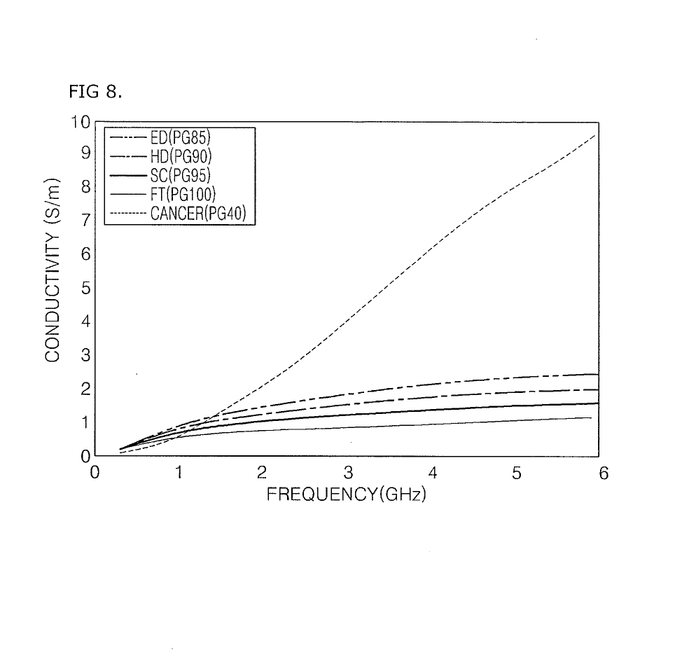

The results of the measurement of relative permittivity and conductivity in the same frequency domain as that of FIGS. 7 and 8 using the imaging phantom of the present invention (FT(PG100), HD(PG90), SC(PG95), FT(PG100), CANCER(PG40)) revealed that the simulated breast tissue phantom had relative permittivity of about 6 to 14 and conductivity of about 0.8 to 1.8 S/m in a frequency of 3 GHz and the simulated cancer tissue phantom had relative permittivity of about 50 to 60 and conductivity of about 1 to 4 S/m in a frequency of 3 GHz to 1.3 GHz.

As described above, it was found that a difference in the relative permittivity, that is, one of the electrical characteristics of the simulated breast tissue and the simulated cancer tissue in accordance with the present invention was about 5 to 6 times and a difference in the conductivity was about 2 to 3 times according to an increase of the frequency. As a result, whether cancer tissue exists or not the position of the cancer tissue can be easily diagnosed by measuring a reflection or scattering wave when a microwave is applied to the breast phantom.

A method of testing reliability of a breast cancer diagnostic apparatus in accordance with another aspect of the present invention includes using the microwave imaging breast phantom.

A method of diagnosing breast cancer using the microwave imaging breast phantom complies with a common method. Any breast cancer diagnostic apparatus using a microwave may be used as the breast cancer diagnostic apparatus.

The present invention can evaluate the reliability and validity of a breast cancer diagnostic apparatus by repeatedly the diagnosis of breast cancer using the microwave imaging breast phantom.

A breast cancer diagnostic apparatus in accordance with yet another aspect of the present invention includes can include the microwave imaging breast phantom.

The breast cancer diagnostic apparatus of the present invention is not specially limited to any apparatus configured to have a common microwave imaging breast phantom or the breast tissue of a human being inserted therein and to diagnose breast cancer.

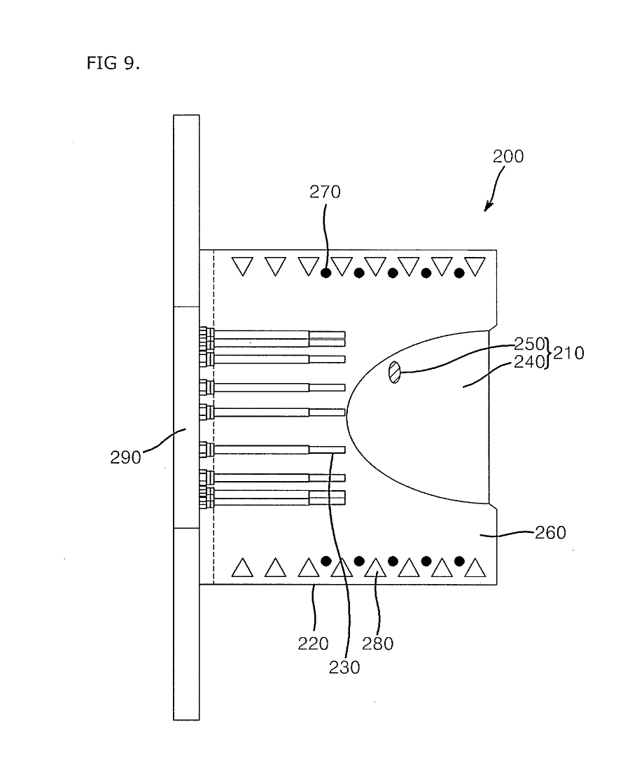

For example, as shown in FIG. 9, a breast cancer diagnostic apparatus 200 of the present invention can include an accommodation unit 220 configured to accommodate a microwave imaging breast phantom 210, a plurality of antennas 230 placed in the accommodation unit 220 and configured to transmit and receive electromagnetic waves, and a processing unit (not shown) connected to the accommodation unit 220 and configured to process information on the amplitude and phase of the electromagnetic waves received from the antennas and diagnose breast cancer based on the processed information.

More particularly, the microwave imaging breast phantom 210 of the breast cancer diagnostic apparatus 200 includes a simulated breast tissue phantom 240 and a simulated cancer tissue phantom 250. The microwave imaging breast phantom 210 is accommodated within the free space 260 of the accommodation unit 220. The plurality of antenna 230 for transmit and receive electromagnetic waves is disposed on the accommodation unit 220, so that external electromagnetic waves can be transmitted and electromagnetic waves can be received from the microwave imaging breast phantom.

The processing unit (not shown) can process information on the amplitude and phase of electromagnetic waves received through the antennas 230 and diagnose breast cancer based on the processed information.

The breast cancer diagnostic apparatus 200 can further include sensors 270 attached to the inner wall of the accommodation unit 220 and configured to determine the size of a microwave imaging breast phantom when the microwave imaging breast phantom is received.

The breast cancer diagnostic apparatus 200 can further include an absorber 280 attached to the inner walls of the accommodation unit 220 and configured to reduce the scattering or interference of electromagnetic waves by absorbing electromagnetic waves emitted toward outside the phantom not the phantom.

Furthermore, the breast cancer diagnostic apparatus 200 can further include a motor 290 mounted at the bottom of the accommodation unit 220 and configured to move the antennas up and down.

In accordance with the phantom for breast cancer diagnostic equipment using microwave imaging according to the present invention, the simulated breast tissue phantom and the simulated cancer tissue phantom have similar electrical characteristics as real breast tissue and real cancer tissue. Accordingly, there is an advantage in that the validity and performance of breast cancer diagnostic equipment in stages prior a clinical stage. Furthermore, there are advantages in that a time problem and a cost problem can be solved because the accuracy and performance of an apparatus can be checked using the microwave imaging breast phantom in a step of developing breast cancer diagnostic equipment using microwave imaging, prior to a clinical test.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A microwave imaging breast phantom, comprising:
a simulated breast tissue phantom and a simulated cancer tissue phantom,
wherein the simulated cancer tissue phantom is included in the simulated breast tissue phantom,
the simulated breast tissue and the simulated cancer tissue are separated from each other,
the simulated breast tissue and the simulated cancer tissue are respectively formed by using a solvent solely or mixing water and a solvent, and
the solvent having a range in which assuming that specific gravity of the water is a and specific gravity of the solvent is b, ‘(b−a)/a×100’ is about −10 to about +10 (wherein 0 is excluded) is mixed with the water.

2. The microwave imaging breast phantom of claim 1, wherein:
the simulated breast tissue phantom has relative permittivity of about 6 to 14 and conductivity of about 0.8 to 1.8 S/m in a frequency of 3 GHz, and
the simulated cancer tissue phantom has relative permittivity of about 50 to 60 and conductivity of about 1 to 4 S/m in a frequency of 3 GHz to 1.3 GHz.

3. The microwave imaging breast phantom of claim 1, wherein:
the simulated breast tissue is formed by mixing the water of about 0 to 15% and the solvent of about 85 to 100% based on content, and
the simulated cancer tissue is formed by mixing the water of about 50 to 60% and the solvent of about 40 to 50% based on content.

4. The microwave imaging breast phantom of claim 1, wherein the solvent is propyleneglycol.

5. The microwave imaging breast phantom of claim 1, wherein the simulated breast tissue and the simulated cancer tissue are separated from each other by a membrane.

6. A method of testing reliability of a breast cancer diagnostic apparatus using a microwave imaging breast phantom according to any one of claims 1 to 5.

7. A breast cancer diagnostic apparatus, comprising:
an accommodation unit configured to accommodate a microwave imaging breast phantom according to any one of claims 1 to 5;
antennas placed on the accommodation unit and configured to transmit and receive electromagnetic waves; and
a processing unit connected to the accommodation unit and configured to process information on an amplitude and phase of the electromagnetic waves received from the antennas and diagnose breast cancer based on the processed information.
